(19) United States
(12) Patent Application Publication
(10) Pub. No.: US 2022/0024050 A1
(43) Pub. Date: Jan. 27, 2022

(54) ELECTRONIC APPARATUS AND METHOD OF CONTROLLING THEREOF

(71) Applicant: Samsung Electronics Co., Ltd., Suwon-si (KR)

(72) Inventors: Hyeontaek LIM, Suwon-si (KR); Sejin KWAK, Suwon-si (KR); Yongkook KIM, Suwon-si (KR)

(21) Appl. No.: 17/086,991

(22) Filed: Nov. 2, 2020

(30) Foreign Application Priority Data
Jul. 24, 2020 (KR) 10-2020-0092089

(51) Int. Cl. B25J 13/08; G01S 3/808; H04N 5/232

(52) U.S. Cl. CPC B25J 13/089; H04N 5/23219; G01S 3/8083

(57) ABSTRACT

An electronic apparatus is provided. The electronic apparatus includes a plurality of microphones, a display, a driver, a sensor configured to sense a distance to an object around the electronic apparatus, and a processor configured to, based on an acoustic signal being received through the plurality of microphones, identify at least one candidate space with respect to a sound source in a space around the electronic apparatus using distance information sensed by the sensor, identify a location of the sound source from which the acoustic signal is output by performing sound source location estimation with respect to the identified candidate space, and control the driver such that the display faces the identified location of the sound source.

### CROSS-REFERENCE TO RELATED APPLICATION(S)

This application is based on and claims priority under 35 U.S.C. § 119(a) of a Korean patent application number 10-2020-0092089, filed on Jul. 24, 2020 in the Korean Intellectual Property Office, the disclosure of which is incorporated by reference herein in its entirety.

### BACKGROUND

### 1. Field

The disclosure relates to an electronic apparatus and a method of controlling thereof. More particularly, the disclosure relates to an electronic apparatus for identifying a location of a sound source and a method of controlling thereof.

### 2. Description of the Related Art

Recently, electronic apparatuses such as robots capable of communicating with users through conversation have been developed.

In order to recognize a user's voice received through a microphone and perform an operation (e.g., a movement toward the user or a direction rotation operation, etc.), the electronic apparatus may need to accurately search for a location of the user uttering the voice. The location of the user uttering the voice may be estimated through the location where the voice is uttered, that is, the location of the sound source.

However, it is difficult to identify an exact location of the sound source in real time with only the microphone. There is a problem in that a large amount of computation is required for a method of processing an acoustic signal received through the microphone and searching for the location of the sound source in units of blocks dividing a surrounding space. When it is necessary to identify the location of a sound source in real time, the amount of calculation increases in proportion to time. This may lead to an increase in power consumption and waste of resources. In addition, there is a problem in that an accuracy of the location of the searched sound source is degraded according to the environment of the surrounding space, for example, noise or reverberation may occur.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, as aspect of the disclosure is to provide an electronic apparatus that improves a user experience for a voice recognition service based on a location of a sound source searched in real time, and a method of controlling thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a plurality of microphones, a display, a driver, a sensor configured to sense a distance to an object around the electronic apparatus, and a processor configured to, based on an acoustic signal being received through the plurality of microphones, identify at least one candidate space with respect to a sound source in a space around the electronic apparatus using distance information sensed by the sensor, identify a location of the sound source from which the acoustic signal is output by performing sound source location estimation with respect to the identified candidate space, and control the driver such that the display faces the identified location of the sound source.

The processor may be configured to identify at least one object having a predetermined shape around the electronic apparats based on distance information sensed by the sensor, and identify the at least one candidate space based on a location of the identified object.

The processor may be configured to identify at least one object having the predetermined shape in a space of an XY axis around the electronic apparatus based on the distance information sensed by the sensor, and with respect to an area where the identified object is located in the space of the XY axis, identify at least one space having a predetermined height in a Z axis as the at least one candidate space.

The predetermined shape may be a shape of a user's foot.

The processor may be configured to map height information on the Z axis of the identified sound source to an object corresponding to the candidate space in which the sound source is located, track a movement trajectory of the object in the space of the XY axis based on the distance information sensed by the sensor, and based on a subsequent acoustic signal output from the same sound source as the acoustic signal being received through the plurality of microphones, identify a location of a sound source from which the subsequent acoustic signal is output based on a location of the object in the space of the XY axis according to the movement trajectory of the object and the height information on the Z axis mapped to the object.

The sound source may be a mouth of the user.

The electronic apparatus may further include a camera, wherein the processor is configured to photograph in a direction where the sound source is located through the camera based on the location of the identified sound source, based on an image photographed by the camera, identify a location of the user's mouth included the image, and control the driver such that the display faces the mouth based on the location of the mouth.

The processor may be configured to divide each of the identified candidate spaces into a plurality of blocks to perform the sound source location estimation that calculates a beamforming power with respect to each block, and identify a location of the block having the largest calculated beamforming power as the location of the sound source.

The electronic apparatus may further include a camera, wherein the processor is configured to identify a location of a first block having the largest beamforming power among the plurality of blocks as the location of the sound source, photograph in a direction in which the sound source is located through the camera based on the location of the identified sound source, based on the user being not existed in the image photographed by the camera, identify a location of a second block having the second-largest beamforming power after the first block as the location of the sound source, and control the driver such that the display faces the sound source based on the location of the identified sound source.

Among a head and a body constituting the electronic apparatus, wherein the display is located on the head, and wherein the processor may be configured to, based on a distance between the electronic apparats and the sound source being less than or equal to a predetermined value, adjust at least one of a direction of the electronic apparats and an angle of the head through the driver such that the display faces the sound source, and based on the distance between the electronic apparatus and the sound source exceeding the predetermined value, move the electronic apparatus to a point distant from the sound source by the predetermined value through the driver, and adjust the angle of the head such that the display faces the sound source.

In accordance with another aspect of the disclosure, a method of controlling an electronic apparatus is provided. The method of controlling an electronic apparatus includes, based on an acoustic signal being received through a plurality of microphones, identifying at least one candidate space with respect to a sound source in a space around the electronic apparatus using distance information sensed by a sensor, identifying a location of the sound source from which the acoustic signal is output performing sound source location estimation with respect to the identified candidate space, and controlling the driver such that the display faces the identified location of the sound source.

The identifying the candidate space may include identifying at least one object having a predetermined shape around the electronic apparats based on distance information sensed by the sensor, and identifying the at least one candidate space based on a location of the identified object.

The identifying the candidate space may include identifying at least one object having the predetermined shape in a space of an XY axis around the electronic apparatus based on the distance information sensed by the sensor, and with respect to an area where the identified object is located in the space of the XY axis, identifying at least one space having a predetermined height in a Z axis as the at least one candidate space.

The identifying the location of the sound source may include mapping height information on the Z axis of the identified sound source to an object corresponding to the candidate space in which the sound source is located, tracking a movement trajectory of the object in the space of the XY axis based on the distance information sensed by the sensor, and based on a subsequent acoustic signal output from the same sound source as the acoustic signal being received through the plurality of microphones, identifying a location of a sound source from which the subsequent acoustic signal is output based on a location of the object in the space of the XY axis according to the movement trajectory of the object and the height information on the Z axis mapped to the object.

The method may further include photographing in a direction where the sound source is located through a camera of the electronic apparatus based on the location of the identified sound source, based on an image photographed by the camera, identifying a location of the user's mouth included the image, and controlling the driver such that the display faces the mouth based on the location of the mouth.

The identifying the location of the sound source may include dividing each of the identified candidate spaces into a plurality of blocks to perform the sound source location estimation that calculates a beamforming power with respect to each block, and identifying a location of the block having the largest calculated beamforming power as the location of the sound source.

The method may further include identifying a location of a first block having the largest beamforming power among the plurality of blocks as the location of the sound source, photographing in a direction in which the sound source is located through the camera based on the location of the identified sound source, based on the user being not existed in the image photographed by the camera, identifying a location of a second block having the second-largest beamforming power after the first block as the location of the sound source, and controlling the driver such that the display faces the sound source based on the location of the identified sound source.

Among a head and a body constituting the electronic apparatus, wherein the display may be located on the head, and may further include, based on a distance between the electronic apparats and the sound source being less than or equal to a predetermined value, adjusting at least one of a direction of the electronic apparats and an angle of the head through the driver such that the display faces the sound source, and based on the distance between the electronic apparatus and the sound source exceeding the predetermined value, moving the electronic apparatus to a point distant from the sound source by the predetermined value through the driver, and adjusting the angle of the head such that the display faces the sound source.

According to various embodiments of the disclosure as described above, an electronic apparatus that improves a user experience for a voice recognition service based on a location of a sound source and a control method thereof may be provided.

In addition, it is possible to provide an electronic apparatus that improves an accuracy of voice recognition by more accurately searching for a location of a sound source, and a control method thereof.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic apparatus according to an embodiment of the disclosure;

FIG. 2 is a view illustrating a configuration of an electronic apparatus according to an embodiment of the disclosure;

FIG. 3 is a view illustrating an operation of an electronic apparatus according to an embodiment of the disclosure;

FIG. 4 is a view illustrating a sensor for sensing distance information according to an embodiment of the disclosure;

FIG. 5 is a view illustrating a method of identifying a candidate space according to an embodiment of the disclosure;

FIG. 6 is a view illustrating a method of identifying a candidate space according to an embodiment of the disclosure;

FIG. 7 is a view illustrating a plurality of microphones that receive sound signals according to an embodiment of the disclosure;

FIG. 8 is a view illustrating an acoustic signal received through a plurality of microphones according to an embodiment of the disclosure;

FIG. 9 is a view illustrating a predetermined delay value for each block according to an embodiment of the disclosure;

FIG. 10 is a view illustrating a method of calculating beamforming power according to an embodiment of the disclosure;

FIG. 11 is a view illustrating a method of identifying a location of a sound source according to an embodiment of the disclosure;

FIG. 12 is a view illustrating an electronic apparatus driven according to a location of a sound source according to an embodiment of the disclosure;

FIG. 13 is a view illustrating an electronic apparatus driven according to a location of a sound source according to an embodiment of the disclosure;

FIG. 14 is a view illustrating a method of identifying a location of a sound source through a movement trajectory according to an embodiment of the disclosure;

FIG. 15 is a view illustrating a method of identifying a location of a sound source through a movement trajectory according to an embodiment of the disclosure;

FIG. 16 is a view illustrating a voice recognition according to an embodiment of the disclosure;

FIG. 17 is a block diagram illustrating an additional configuration of an electronic apparatus according to an embodiment of the disclosure; and

FIG. 18 is a view illustrating a flowchart according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expression “1”, “2”, “first”, or “second” as used herein may modify a variety of elements, irrespective of order and/or importance thereof, and only to distinguish one element from another. Accordingly, without limiting the corresponding elements.

In the description, the term “A or B”, “at least one of A or/and B”, or “one or more of A or/and B” may include all possible combinations of the items that are enumerated together. For example, the term “A or B” or “at least one of A or/and B” may designate (1) at least one A, (2) at least one B, or (3) both at least one A and at least one B.

The singular expression also includes the plural meaning as long as it does not differently mean in the context. The terms “include”, “comprise”, “is configured to,” etc., of the description are used to indicate that there are features, numbers, operations, elements, parts or combination thereof, and they should not exclude the possibilities of combination or addition of one or more features, numbers, operations, elements, parts or a combination thereof.

When an element (e.g., a first element) is “operatively or communicatively coupled with/to” or “connected to” another element (e.g., a second element), an element may be directly coupled with another element or may be coupled through the other element (e.g., a third element). On the other hand, when an element (e.g., a first element) is “directly coupled with/to” or “directly connected to” another element (e.g., a second element), an element may not be existed between the other element.

In the description, the term “configured to” may be changed to, for example, “suitable for”, “having the capacity to”, “designed to”, “adapted to”, “made to”, or “capable of” under certain circumstances. The term “configured to (set to)” does not necessarily mean “specifically designed to” in a hardware level. Under certain circumstances, the term “device configured to” may refer to “device capable of” doing something together with another device or components. For example, “a sub-processor configured (or configured to) perform A, B, and C” may refer to a generic-purpose processor (e.g., central processing unit (CPU) or an application processor) capable of performing corresponding operations by executing a dedicated processor (e.g., an embedded processor) or one or more software programs stored in a memory device to perform the operations.

An electronic apparatus according to various embodiments of the disclosure may include, for example, at least one of a smart phone, a tablet PC (Personal Computer), a mobile phone, a video phone, an e-book reader, a desktop PC (Personal Computer), a laptop PC (Personal Computer), a net book computer, a workstation, a server, a PDA (Personal Digital Assistant), a PMP (Portable Multimedia Player), an MP3 player, a mobile medical device, a camera, and a wearable device. Wearable devices may include at least one of accessories (e.g. watches, rings, bracelets, anklets, necklaces, glasses, contact lenses, or head-mounted-devices (HMD)), fabrics or clothing (e.g. electronic clothing), a body attachment type (e.g., a skin pad or a tattoo), or a bio-implantable circuit.

In other embodiments, the electronic apparatus may include at least one of, for example, televisions (TVs), digital video disc (DVD) players, audios, refrigerators, air conditioners, cleaners, ovens, microwave ovens, washing machines, air cleaners, set-top boxes, home automation control panels, security control panels, media boxes (for example, Samsung HomeSync™, Apple TV™, or Google TV™), game consoles (for example, Xbox™ and PlayStation™), electronic dictionaries, electronic keys, camcorders, or electronic picture frames.

In other embodiments, the electronic apparatus may include at least one of various medical devices (for example, various portable medical measuring devices (such as a blood glucose meter, a heart rate meter, a blood pressure meter, a body temperature meter, or the like), a magnetic resonance angiography (MRA), a magnetic resonance imaging (MRI), a computed tomography (CT), a photographing device, an ultrasonic device, or the like), a navigation device, a global navigation satellite system (GNSS), an event data recorder (EDR), a flight data recorder (FDR), an automobile infotainment device, a marine electronic equipment (for example, a marine navigation device, a gyro compass, or the like), avionics, a security device, an automobile head unit, an industrial or household robot, an automatic teller's machine of a financial institute, a point of sales (POS) of a shop, and Internet of things (IoT) devices (for example, a light bulb, various sensors, an electric or gas meter, a sprinkler system, a fire alarm, a thermostat, a street light, a toaster, an exercise equipment, a hot water tank, a heater, a boiler, and the like).

According to another embodiment of the disclosure, the electronic apparatus may include at least one of portions of furniture or a building/structure, an electronic board, an electronic signature receiving device, a projector, or various measurement devices (e.g. water, electricity, gas, or radio wave measurement devices, etc.). In various embodiments, the electronic apparatus may be a combination of one or more of the above-described devices. In a certain embodiment, the electronic apparatus may be a flexible electronic apparatus. Further, the electronic apparatus according to the embodiments of the disclosure is not limited to the above-described devices, but may include new electronic apparatuses in accordance with the technical development.

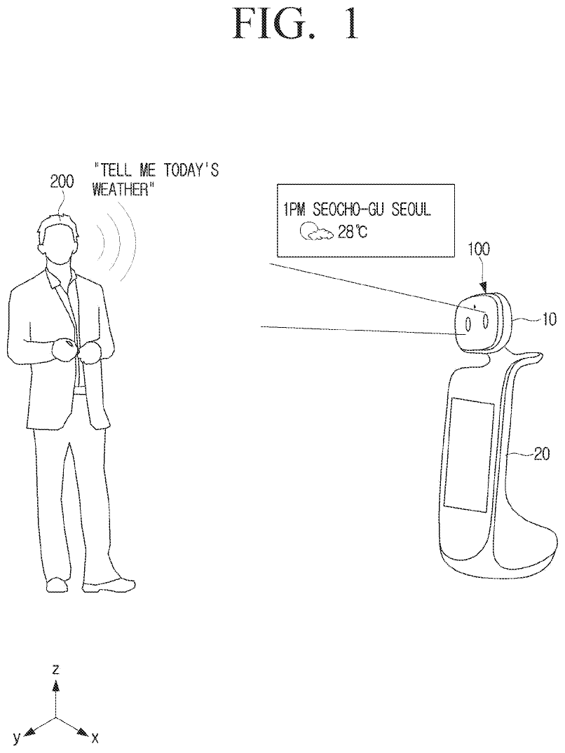

FIG. 1 is a view illustrating an electronic apparatus according to an embodiment of the disclosure.

Referring to FIG. 1, the electronic apparatus 100 according to an embodiment of the disclosure may be implemented as a robot device. The electronic apparatus 100 may be implemented as a fixed robot device that is rotationally driven in a fixed location, or may be implemented as a mobile robot device that can move a location through driving or flying. Furthermore, the mobile robot device may be capable of rotational driving.

The electronic apparatus 100 may have various shapes such as humans, animals, characters, or the like. An exterior of the electronic apparatus 100 may include a head 10 and a body 20. The head 10 may be coupled to the body 20 while being located at a front portion of the body 20 or an upper end portion of the body 20. The body 20 may be coupled to the head 10 to support the head 10. In addition, the body 20 may be provided with a traveling device or a flight device for driving or flying.

However, the embodiment described above is only an example, and the exterior of the electronic apparatus 100 may be transformed into various shapes, and the electronic apparatus 100 may be implemented as various types of electronic apparatuses including a portable terminal such as a smart phone, a tablet PC, or the like, or home appliances such as a TV, refrigerators, washing machines, air conditioners, robot cleaners, or the like.

The electronic apparatus 100 may provide a voice recognition service to a user 200. The electronic apparatus 100 may receive an acoustic signal. In this case, the sound signal (or audio signal) refers to a sound wave transmitted through a medium (e.g., air, water, etc.), and may include information such as frequency, amplitude, waveform, or the like. In addition, the sound signal may be generated by the user 200 uttering a voice for a specific word or sentence through a body (e.g., vocal cords, mouth, etc.). In other words, the sound signal may include the user's 200 voice expressed by information such as frequency, amplitude, waveform, or the like. For example, referring to FIG. 1, the sound signal may be generated by the user 200 uttering a voice such as “tell me today's weather”. Meanwhile, unless there is a specific description, it is assumed that the user 200 is a user who uttered a voice in order to receive a voice recognition service.

In addition, the electronic apparatus 100 may obtain text corresponding to the voice included in the sound signal by analyzing the sound signal through various types of voice recognition models. The voice recognition model may include information on vocal information that utters a specific word or syllable that forms part of a word, and unit phoneme information. Meanwhile, the sound signal is an audio data format, and the text is a language that can be understood by a computer and may be a text data format.

The electronic apparatus 100 may perform various operations based on the obtained text. For example, when a text such as “tell me today's weather” is obtained, the electronic apparatus 100 may output weather information on a current location and today's date through a display and/or a speaker of the electronic apparatus 100.

Tn order to provide the voice recognition service that outputs information through the display or speaker of the electronic apparatus 100, the electronic apparatus 200 may need to be located at a distance closer to the user 200 based on the current location of the user 200 (e.g., visual or auditory range of the user 200). In order to provide a voice recognition service that performs an operation based on the location of the user 200 (e.g., an operation that brings an object to the user 200), the electronic apparatus 100 may be required to be a current location of the user 200. In order to provide a voice recognition service that communicates with the user 200, the electronic apparatus 100 may be required to drive a head 10 toward the location of the user 200 uttering the voice. This is because that psychological discomfort may be generated to the user 200 who receives the voice recognition service if the head 10 of the electronic apparatus 100 does not face a face of the user 200 (i.e., in case of not making eye contact). As such, it may be necessary to accurately identify the location of the user 200 who uttered the voice in various situations in real time.

The electronic apparatus 100 according to an embodiment of the disclosure may provide various voice recognition services to the user 200 by using a location of a sound source from which an acoustic signal is output.

The electronic apparatus 100 may sense a distance to an object around the electronic apparatus 100 and identify a candidate space in a space around the electronic apparatus 100 based on the sensed distance information. This may reduce the amount of calculation of sound source location estimation by limiting a target for which the sound source location estimation to be described below is performed to a candidate space in which a specific object exists among the spaces around the electronic apparatus 100, not all spaces around the electronic apparatus 100. In addition, this makes it possible to identify the location of the sound source in real time, and improve an efficiency of resources.

In addition, when the sound signal is received, the electronic apparatus 100 may identify the location of the sound source from which the sound signal is output by performing sound source location estimation on the candidate space. The sound source may represent a mouth of the user 200. The location of the sound source may thus indicate the location of the mouth (or face) of the user 200 from which the sound signal is output, and may be expressed in various ways such as 3D spatial coordinates. The location of the sound source may be used as a location of the user 200 to distinguish the user from other users.

The electronic apparatus 100 may drive the display to face the sound source based on the location of the identified sound source. For example, the electronic apparatus 100 may rotate or move the display to face the sound source based on the location of the identified sound source. The display may be disposed or formed on at least one of the head 10 and the body 20 that form the exterior of the electronic apparatus 100.

As such, the electronic apparatus 100 may conveniently transmit various information displayed through the display to the user 200 by driving the display so that the display is located within a visible range of the user 200. In other words, the user 200 may receive information through the display of the electronic apparatus 100 located in the visible range without a separate movement, and thus user convenience may be improved.

In addition, when the display is disposed on the head 10 of the electronic apparatus 100, the electronic apparatus 100 may rotate the display together with the head 10 to gaze at the user 200. For example, the electronic apparatus 100 may rotate the display together with the head 10 so as to face the location of the mouth (or face) of the user 200. In this case, the display disposed on the head 10 may display an object representing an eye or a mouth. Accordingly, a user experience related to more natural communication may be provided to the user 200.

Hereinafter, the disclosure will be described in greater detail with reference to the accompanying drawings.

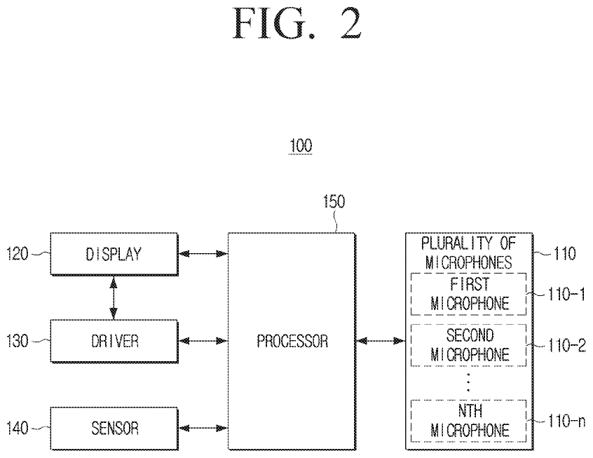

FIG. 2 is a block diagram illustrating a configuration of an electronic apparatus according to an embodiment of the disclosure.

Referring to FIG. 2, the electronic apparatus 100 may include a plurality of microphones 110, a display 120, a driver 130, a sensor 140, and a processor 150.

Each of the plurality of microphones 110 is configured to receive an acoustic signal. The sound signal may include a voice of the user 200 expressed by information such as frequency, amplitude, waveform, or the like.

The plurality of microphones 110 may include a first microphone 110-1, a second microphone 110-2, . . . , an n-th microphone 110-n. The n may be a natural number of 2 or more. As the number of the plurality of microphones 110 increases, the performance for estimating the location of the sound source may increase. However, there is a disadvantage in that the amount of calculation increases in proportion to the number of the plurality of microphones 110. The number of the plurality of microphones 110 of the disclosure may be in a range of 4 to 8, but is not limited thereto and may be modified in various numbers.

Each of the plurality of microphones 110 may be disposed at different locations to receive sound signals. For example, the plurality of microphones 110 may be disposed on a straight line, or may be disposed on a vertex of a polygon or polyhedron. The polygon refers to various planar figures such as triangles, squares, pentagons, or the like, and the polyhedron refers to various three-dimensional figures such as tetrahedron (trigonal pyramid, etc.), pentahedron, cube, or the like. However, this is only an example, and at least some of the plurality of microphones 110 may be disposed at vertices of a polygon or a polyhedron, and the remaining parts may be disposed inside a polygon or a polyhedron.

The plurality of microphones 110 may be disposed to be spaced apart from each other by a predetermined distance. The distance between adjacent microphones among the plurality of microphones 110 may be the same, but this is only an example, and the distance between adjacent microphones may be different.

Each of the plurality of microphones 110 may be integrally implemented with the upper side, the front direction, and the side direction of the electronic apparatus 100, or may be provided separately and connected to the electronic apparatus 100 through a wired or wireless interface.

The display 120 may display various user interfaces (UI), icons, figures, characters, images, or the like.

For this operation, the display 120 may be implemented in various types of displays such as a liquid crystal display (LCD) that uses a separate backlight unit (e.g., a light emitting diode (LED)) as a light source and controls a molecular arrangement of the liquid crystal, so that the light emitted from the backlight unit adjusts a degree (brightness of light or intensity of light) passed through the liquid crystal, and a display that uses a self-luminous element (e.g. mini LED of 100-200 um, micro LED of 100 um or less, Organic LED (OLED), Quantum dot LED (QLED), etc.) as a light source without a separate backlight unit or liquid crystal, or the like. Meanwhile, the display 120 may be implemented in a form of a touch screen capable of sensing a user's touch manipulation, and the display 120 may be implemented as a flexible display which can bend or fold a certain part and unfold again, or the display 120 may be implemented as a transparent display having a characteristic of making objects located behind the display 120 transparent to be visible.

The electronic apparatus 100 may include one or more displays 120. The display 120 may be disposed on at least one of the head 10 and the body 20. When the display 120 is disposed on the head 10, the display 120 disposed on the head 10 may be rotated together when the head 10 is rotatably driven. In addition, when the body 20 coupled with the head 10 is driven to move, the head 10 or the display 120 disposed on the body 20 may be moved together as a result.

The driver 130 is a component for moving or rotating the electronic apparatus 100. For example, the driver 130 functions as a rotation device while being coupled between the head 10 and the body 20 of the electronic apparatus 100, and rotates the head 10 around an axis perpendicular to the Z axis or rotates around the Z axis. Alternatively, the driver 130 may be disposed on the body 20 of the electronic apparatus 100 to function as a traveling device or a flying device, and may move the electronic apparatus 100 through traveling or flying.

For this operation, the driver 130 may include at least one of an electric motor, a hydraulic device, and a pneumatic device that generate power using electricity, hydraulic pressure, compressed air, or the like. Alternatively, the driver 130 may further include a wheel for driving or an air injector for flight.

The sensor 140 may sense a distance (or depth) with an object around the electronic apparatus 100. For this operation, the sensor 140 may sense a distance with an object existed in a surrounding space of the sensor 140 or the electronic apparatus 100 through a variety of methods such as a time of flight (TOF) method, a phase-shift method, or the like.

The TOF method may sense a distance by measuring a time when the sensor 140 emits a pulse signal such as a laser, or the like, and the pulse signal reflected and returned from an object existing in the space (within a measurement range) around the electronic apparatus 100 arrives at the sensor 140. The phase-shift method may sense a distance by emitting a pulse signal such as a laser, or the like, that is continuously modulated with a specific frequency, and measuring a phase change amount of the pulse signal reflected from the object and returned. In this case, the sensor 140 may be implemented as a light detection and ranging (LiDAR) sensor, an ultrasonic sensor, or the like according to the type of the pulse signal.

The processor 150 may control the overall operation of the electronic apparatus 100. For this operation, the processor 150 may be implemented as a general-purpose processor such as a central processing unit (CPU), an application processor (AP), etc., a graphics-only processor such as a graphic processing unit (GPU), a vision processing unit (VPU), etc., and a neural processing unit (NPU). Also, the processor 150 may include a volatile memory for loading at least one instruction or module.

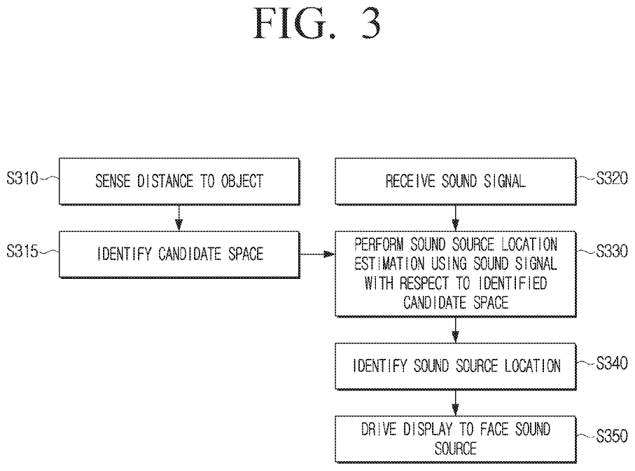

When sound signals are received through the plurality of microphones 110, the processor 150 may identify at least one candidate space for a sound source in the space around the electronic apparatus 100 based on distance information sensed by the sensor 140, and identify the location of the sound source from which acoustic signal is output by performing sound source location estimation with respect to the identified candidate space, and control the driver so that the display faces the identified location of the sound source. Detailed descriptions will be described with reference to FIG. 3.

FIG. 3 is a view illustrating an operation of an electronic apparatus according to an embodiment of the disclosure.

Referring to FIG. 3, the processor 150 may sense a distance to an object existing in a space around the electronic apparatus 100 through the sensor 140 in operation S310. The processor 150 may sense a distance to an object existing within a predetermined distance with respect to the space around the electronic apparatus 100 through the sensor 140.

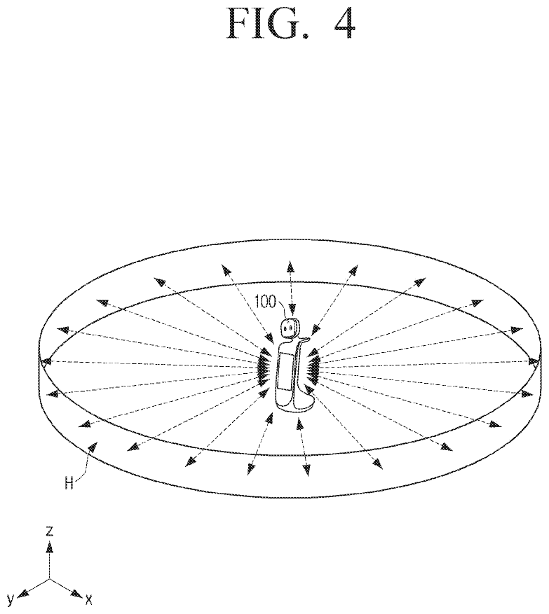

The space around the electronic apparatus 100 may be a space on an XY axis within a distance that can be sensed through the sensor 140. However, this is only an example, and the space may be a space on an XYZ axis within a distance that can be sensed through the sensor 140. For example, referring to FIG. 4, through the sensor 140, a distance to an object existing within a predetermined distance in all directions such as front, side, rear, etc. with respect to the space around the electronic apparatus 100 may be sensed.

The processor 150 may identify at least one candidate space based on distance information sensed by the sensor 140 in operation S315. The processor 150 may identify at least one object having a predetermined shape around the electronic apparatus 100 based on the distance information sensed by the sensor 140.

The processor 150 may identify at least one object having a predetermined shape in an XY axis space around the electronic apparatus 100 based on the distance information sensed by the sensor 140.

The predetermined shape may be a shape of the user's 200 foot. The shape represents a curvature, a shape, a size, etc. of the object in the XY axis space. In addition, the shape of the user's 200 foot may be a pre-registered shape of a specific user's foot or an unregistered shape of a general user's foot. However, this is only an example, and the predetermined shape may be set to various shapes, such as a shape of a part of the body of the user 200 (e.g., a shape of the face, a shape of the upper or lower body) or a shape of the body of the user 200.

For example, the processor 150 may classify an object (or cluster) by combining adjacent spatial coordinates where a distance difference is less than or equal to a predetermined value based on the distance information sensed for each spatial coordinate, and identify the shape of the object according to the distance for each spatial coordinate of the classified object. The processor 150 may compare the shape of each identified object and a similarity of the predetermined shape through various methods such as histogram comparison, template matching, feature matching, or the like, and identify an object that similarity exceeds a predetermined value as an object having a predetermined shape.

In this case, the processor 150 may identify at least one candidate space based on a location of the identified object. The candidate space may refer to a space which is estimated to have a high possibility that the user 200 who uttered voice exists. The candidate space is introduced for the purpose of reducing the amount of calculation of sound source location estimation by reducing the space subject to calculation of sound source location estimation, and promoting resource efficiency. In addition, compared to the case of using only a microphone, the location of the sound source may be more accurately searched by using the sensor 140 that senses a physical object.

The processor 150 may identify at least one space having a predetermined height in a Z axis as at least one candidate space with respect to a space in which the identified object is located in the space of the XY axis. The height predetermined in the Z axis may be a value in consideration of the height of the user 200. For example, the height predetermined in the Z axis may be a value corresponding to within a range of 100 cm to 250 cm. In addition, the height predetermined in the Z axis may be a pre-registered height of a specific user or a height of a general user who is not registered. However, this is only an example, and the height predetermined in the Z axis may be modified to have various values.

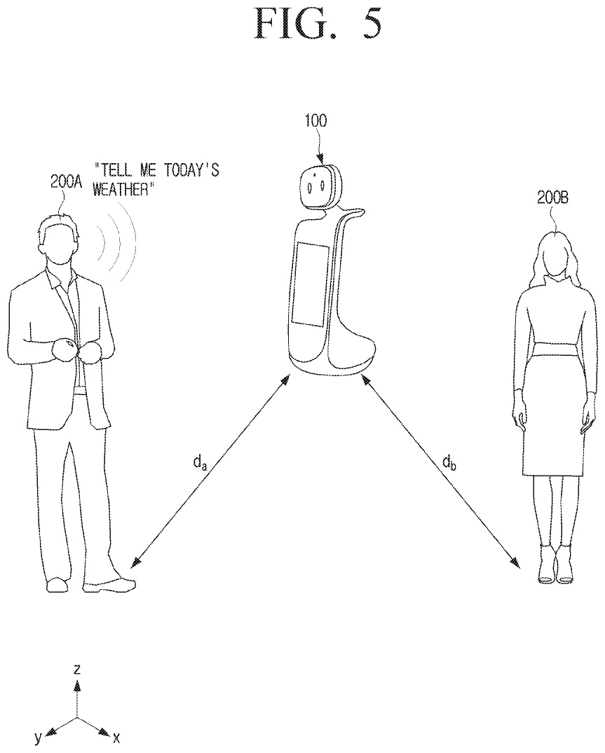

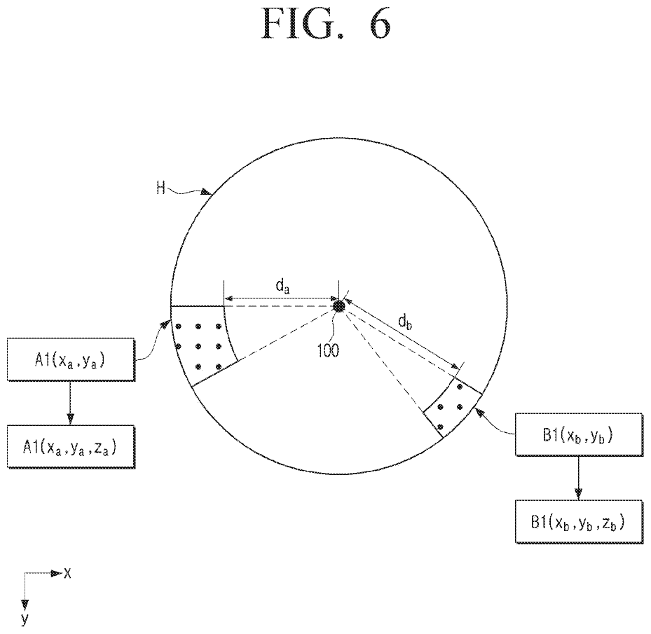

As a specific embodiment of identifying a candidate space, a description will be given with reference to FIGS. 5 and 6.

FIGS. 5 and 6 are views illustrating a method of identifying a candidate space according to an embodiment of the disclosure.

Referring to FIGS. 5 and 6, the processor 150 may sense a distance to an object existing in a space of an XY axis (or horizontal space in all orientations) H, which is a space around the electronic apparatus 100 through the sensor 140. In this case, the processor 150 may sense a distance da to a user A 200A through the sensor 140. In addition, the processor 150 may combine adjacent spatial coordinates where the difference between the distance da and the distance is less than or equal to a predetermined value into one area, and classify the combined area (e.g., A1(xa, ya)) as one object A. The processor 150 may identify a shape of the object A based on a distance (e.g., da, etc.) of each point of the object A. If it is assumed that the shape of the object A is identified to have a shape of a foot, the processor 150 may identify a space (e.g., A1(xa, ya, za)) having a predetermined height in the Z axis as a candidate space with respect to the area where the identified object A is located (e.g., A1(xa, ya)). Similarly, the processor 150 may identify one candidate space (e.g., B1(xb, yb, zb)) by sensing the distance d b from a user B 200B.

In addition, the processor 150 may receive an acoustic signal through the plurality of microphones 110 in operation S320. As an embodiment, the sound signal may be generated by the user 200 uttering a voice. In this case, a sound source may be a mouth of the user 200 from which the sound signal is output.

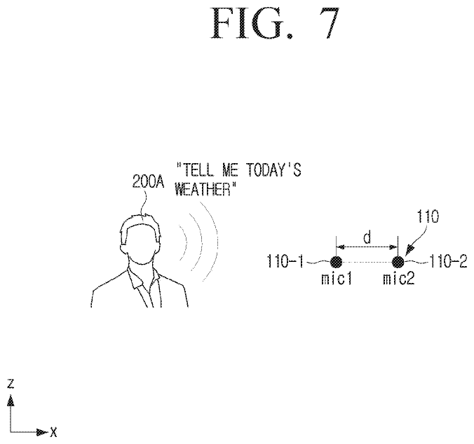

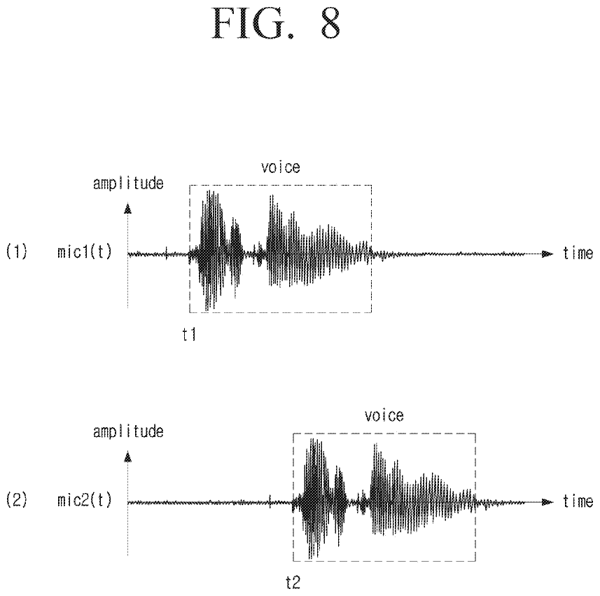

A specific embodiment of receiving an acoustic signal is described below with reference to FIGS. 7 and 8.

FIG. 7 is a view illustrating a plurality of microphones that receive sound signals according to an embodiment of the disclosure. FIG. 8 is a view illustrating an acoustic signal received through a plurality of microphones according to an embodiment of the disclosure.

Referring to FIGS. 7 and 8, a plurality of microphones 110 may be disposed at different locations. For convenience of description, it is assumed that the plurality of microphones 110 include a first microphone 110-1 and a second microphone 110-2 arranged along the X axis.

An acoustic signal generated when the user A 200A utters a voice such as “tell me today's weather” may be transmitted to the plurality of microphones 110. In this case, the first microphone 110-1 disposed at a location closer to the user A 200A may receive an acoustic signal as shown in (1) of FIG. 8 from t1 seconds earlier than the second microphone 110-2, and the second microphone 110-2 disposed at a location farther from the user A 200A may receive the sound signal as shown in (2) of FIG. 8 from t2 seconds later than the first microphone 110-1. In this case, the difference between t1 and t2 may be expressed as a ratio of a distance d between the first microphone 110-1 and the second microphone 110-2 to a speed of a sound wave.

The processor 150 may extract a voice section through various methods such as Voice Activity Detection (VAD) or End Point Detection (EPD) with respect to sound signals received through the plurality of microphones 110.

The processor 150 may identify a direction of the sound signal through a Direction of Arrival (DOA) algorithm with respect to the sound signals received through the plurality of microphones 110. For example, the processor 150 may identify a moving direction (or traveling angle) of the sound signal through the order of the sound signals received by the plurality of microphones 110 in consideration of an arrangement relationship of the plurality of microphones 110.

When the sound signal is received through the plurality of microphones 110 in operation S320, the processor 150 may perform sound source location estimation on the identified candidate space in operation S330. The sound source location estimation may be various algorithms such as Steered Response Power (SRP), Steered Response Power-phase transform (SRP-PHAT), or the like. In this case, the SRP-PHAT or the like may be a grid search method that searches all spaces on a block-by-block basis to find the location of the sound source.

The processor 150 may divide each of the identified candidate spaces into a plurality of blocks. Each block may have a unique xyz coordinate value in space. For example, each block may exist in a virtual space with respect to an acoustic signal. In this case, the virtual space may be matched with a space sensed by the sensor 140.

The processor 150 may perform sound source location estimation that calculates beamforming power for each block.

For example, the processor 150 may apply a delay value predetermined in each block to the sound signals received through the plurality of microphones 110 and combine the sound signals with each other. The processor 150 may generate one sound signal by adding a plurality of delayed sound signals according to a predetermined delay time (or frequency, etc.) in block units. In this case, the processor 150 may extract only a signal within a sound section among the sound signals, apply a delay value to the extracted plurality of signals, and combine them into one sound signal. The beamforming power may be the largest value (e.g., the largest amplitude value) within a voice section of the summed sound signal.

The predetermined delay value for each block may be a set value in consideration of a direction in which the plurality of microphones 110 are arranged and a distance between the plurality of microphones 110 so that the highest beamforming power can be calculated for an exact location of an actual sound source. Accordingly, the delay value predetermined for each block may be the same or different with respect to each microphone.

In addition, the processor 150 may identify the location of the sound source from which the sound signal is output in operation S340. In this case, the location of the sound source may be a location of a mouth of the user 200 who uttered the voice.

The processor 150 may identify the location of the block having the largest calculated beamforming power as the location of the sound source.

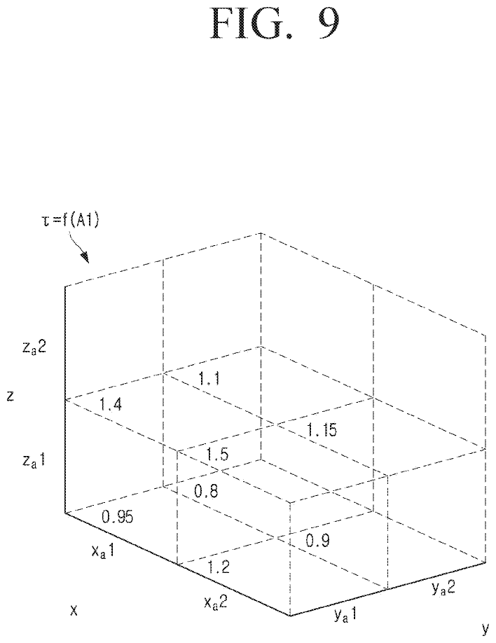

A specific embodiment of identifying the location of a sound source is described below with reference to FIGS. 9 to 11.

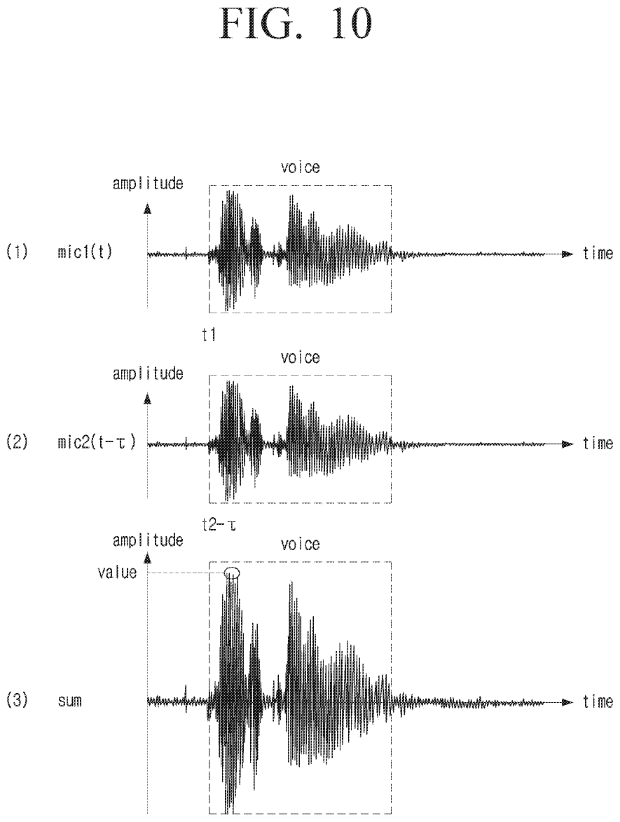

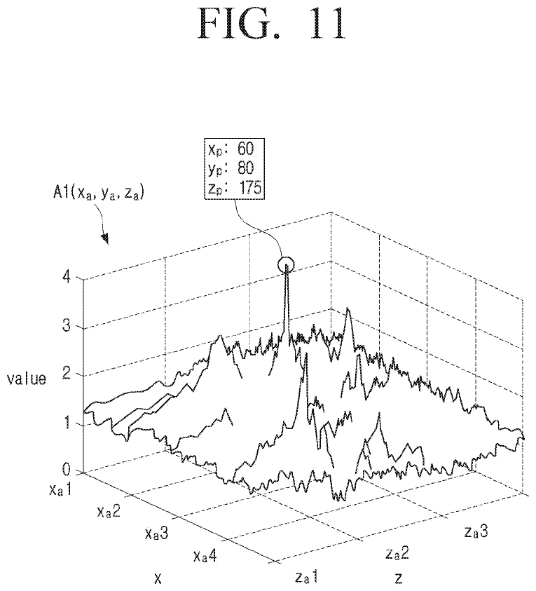

FIG. 9 is a view illustrating a predetermined delay value for each block according to an embodiment of the disclosure. FIG. 10 is a view illustrating a method of calculating beamforming power according to an embodiment of the disclosure. FIG. 11 is a view illustrating a method of identifying a location of a sound source according to an embodiment of the disclosure.

Referring to FIGS. 9-11, it is assumed that the identified candidate space is A1 (xa, ya, za) as shown in FIG. 6, and the sound signals received through the plurality of microphones 110 are the same signals as shown in FIG. 8. In addition, for convenience of description, it is assumed that a delay value is applied to the sound signals received through the second microphone 110-2.

Referring to FIG. 9, the processor 150 may divide the identified candidate space A1 (xa, ya, za) into a plurality of blocks (e.g., 8 blocks in the case of FIG. 9) such as (xa1, ya1, za1) to (xa2, ya2, za2), etc. In this case, the blocks may have a predetermined size unit. Each block may correspond to a spatial coordinate sensed through the sensor 140.

The processor 150 may apply the predetermined delay value matched to each of the plurality of blocks to the sound signals received through the second microphone 110-2. In this case, the predetermined delay value τ may vary according to an xyz value of blocks. For example, as shown in FIG. 9, a delay value predetermined on (xa1, ya1, za1) blocks may be 0.95, and a delay value predetermined on (xa2, ya2, za2) may be 1.15. In this case, an acoustic signal mic2(t) in a form of (2) of FIG. 8 may be shifted by a delay value τ predetermined to an acoustic signal mic2 (t−τ) in a form of (2) of FIG. 10.

Referring to FIG. 10, the processor 150 may calculate an acoustic signal sum in the form of (3) of FIG. 10, if an acoustic signal mic1(t) in a form of FIG. 10 (1) is added (or synthesized) with an acoustic signal mic2(t−τ) in a form of FIG. 10 (2) to which a predetermined delay value τ is applied. In this case, the processor 150 may determine the largest amplitude value in a voice section within a summed sound signal as a beamforming power.

The processor 150 may perform such a calculation process for each block. In other words, the number of blocks and the amount of calculation or the number of calculation may have a proportional relationship.

Referring to FIG. 11, when the processor 150 calculates beamforming power for all blocks in a candidate space, data in the form of FIG. 11 may be calculated as an example. The processor 150 may identify (xp, yp, zp), which is a location of the block having the largest beamforming power, as the location of the sound source.

In addition, the processor 150 according to an embodiment of the disclosure may identify the location of the block having the largest beamforming power among the synthesized sound signals as a location of the sound source, and may perform a voice recognition through a voice section in the synthesized sound signal corresponding to the location of the identified sound source. Accordingly, noise may be suppressed, and only a signal corresponding to a voice section may be reinforced.

In addition, when the received sound signal contains voices uttered by a plurality of users, an acoustic signal is synthesized by applying a delay value in a candidate space unit, and a voice recognition may be performed by separating a voice section according to the location of the identified sound source by identifying the location of the block with the largest beamforming power in the candidate space unit as the location of the sound source. Accordingly, even when there are multiple speakers, there is an effect of being able to accurately recognize each voice.

The processor 150 according to an embodiment of the disclosure may perform an operation S315 of identifying a candidate space immediately after an operation S310 of sensing a distance to an object as shown in FIG. 3. However, this is only an embodiment, and the processor 150 may perform an operation S315 of identifying the candidate space after an acoustic signal is received, and perform an operation S330 of estimating a location of the sound source for the identified candidate space.

When identifying the candidate space after the sound signal is received, the processor 150 may identify a space in which an object located in a moving direction of the sound signal among objects having a predetermined shape exists as the candidate space.

For example, as shown in FIG. 5, the processor 150 may identify a user A (200A) located on the left side of the electronic apparatus 100 and a user B (200AB) located on the right side of the electronic apparatus 100 as an object of a predetermined shape based on distance information sensed through the sensor 140. If the user A (200A) located in the left side of the electronic apparatus 100 uttered a voice such as “tell me today's weather”, an acoustic signal located in the left direction among the plurality of microphones 110 is first received, and the sound signal may be transmitted to a microphone located in the right direction. In this case, the processor 150 may identify that a moving direction of the sound signal is from left to right based on an arrangement relationship of the plurality of microphones 110 and time of the sound signal transmitted to each of the plurality of microphones 110. In addition, the processor 150 may identify a space where the user A 200A is located as a candidate space among a space where the user A 200A is located and a space where the user B 200B is located. In this way, since the number of candidate spaces can be reduced, the amount of calculation is further reduced.

The processor 150 may control the driver 130 so that the display 120 faces the identified location of the sound source in operation S350.

The display 120 may be located on a head 10 among the head 10 and the body 20 constituting the electronic apparatus 100.

When a distance between the electronic apparatus 100 and the sound source is less than or equal to a predetermined value, the processor 150 may adjust at least one of a direction of the electronic apparatus 100 and an angle of the head 10. In this case, the processor 150 may control the driver 130 so that the display 120 located on the head 10 faces the location of the identified sound source. For example, the processor 150 may control the driver 130 to rotate the head 10 so that the display 120 rotates together. In this case, the head 10 and the display 120 may rotate around an axis perpendicular to a Z axis, but this is only an embodiment and may rotate around the Z axis.

The processor 150 may control the display 120 of the head 10 to display an object representing an eye or an object representing a mouth. In this case, the object may be an object that provides effects such as eye blinking and/or mouth movement. As another example, instead of the display 120, a structure representing the eyes and/or mouth may be formed or attached to the head 10.

Alternatively, when a distance between the electronic apparatus 100 and a sound source exceeds a predetermined value, the processor 150 may move the electronic apparatus 100 to a point away from the sound source by a predetermined distance through the driver, and adjust the angle of the head 10 so that the display 120 faces the sound source.

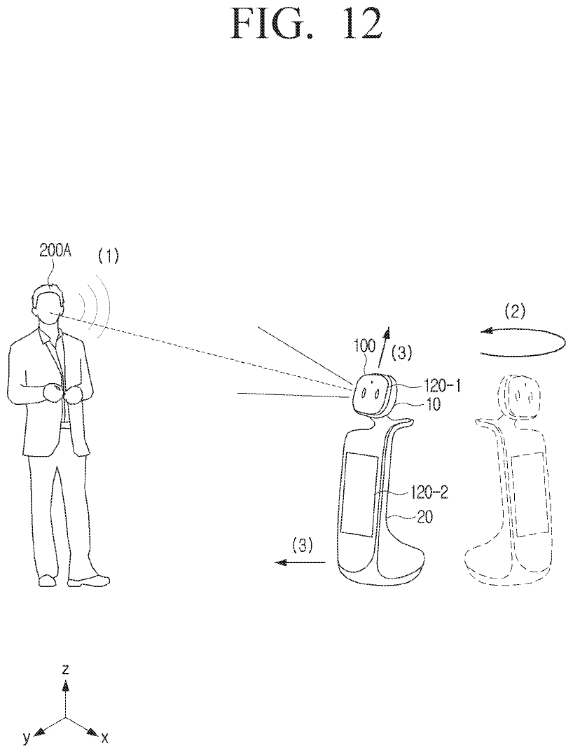

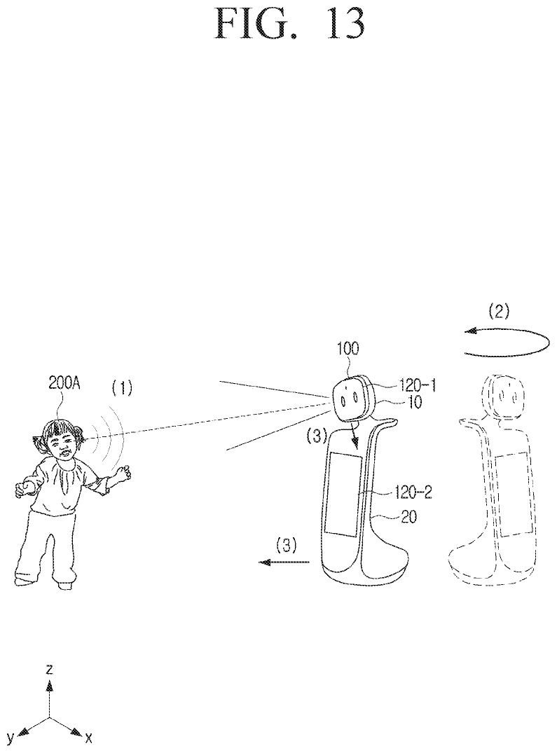

A specific embodiment that the electronic apparatus 100 drives will be described below with reference to FIGS. 12 and 13.

FIGS. 12 and 13 are views illustrating an electronic apparatus driven according to a location of a sound source according to an embodiment of the disclosure. In the case of FIG. 12, a Z value of a location of an identified sound source is greater than that of FIG. 13, and in the case of FIG. 13, the Z value of the location of the identified sound source is smaller than that of FIG. 12.

Referring to FIGS. 12 and 13, when an acoustic signal including a voice uttered by user A 200A is received, the processor 150 may identify a location of the sound source according to the above description. In this case, the location of the sound source may be estimated as the location of user A 200A.

For example, the processor 150 may control the driver 130 so that the locations of the display 120-1 disposed in front of the head 10 and the display 120-2 disposed in the front of the body 20 face the location of the sound source. If it is assumed that the displays 120-1 and 120-2 disposed in front of the head 10 and the body 20 of the electronic apparatus 100 do not face the location of the sound source, the processor 150 may control the driver to rotate the electronic apparatus 100 so that the displays 120-1 and 120-2 disposed in front of the head 10 and the body 20 of the electronic apparatus 100 face the location of the sound source.

Further, the processor 150 may adjust the angle of the head 10 through the driver 130 so that the head 10 faces the location of the sound source.

For example, referring to FIG. 12, when a height on the Z axis of the head 10 is smaller than a height on the Z axis, which is the location of the sound source (e.g., the location of the user A 200A's face), the angle of the head 10 may be adjusted in a direction in which the angle relative to the plane on the XY axis is increased. As another example, referring to FIG. 13, when the height on the Z axis of the head 10 is greater than the height on the Z axis, which is the location of the sound source (e.g., the location of the user A (200A)'s face), the angle of the head 10 may be adjusted in a direction in which an angle relative to the plane on the XY axis is decreased. In this case, as a distance between the electronic apparatus 100 and the sound source is closer, the angle of the adjusted head 10 may increase.

In addition, when a distance between the electronic apparatus 100 and the sound source exceeds a predetermined value, the processor may move the electronic apparatus 100 to a point distant from the sound source by a predetermined distance through the driver 130 so that the display 120 faces the sound source. The processor 150 may adjust the angle of the head 10 through the driver 130 so that the display 120 faces the sound source while the electronic apparatus 100 is moving.

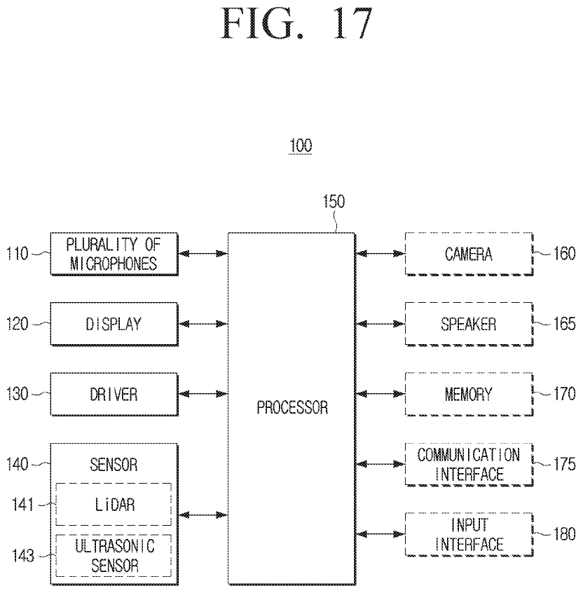

The electronic apparatus 100 according to an embodiment of the disclosure may further include a camera 160, as shown in FIG. 17. The camera 160 may acquire an image by photographing a photographing area in a specific direction. For example, the camera 160 may acquire an image as a set of pixels by sensing light coming from a specific direction in pixel units.

The processor 150 may perform photographing in a direction in which the sound source is located through the camera 160 based on a location of the identified sound source. This is to more accurately identify the location of the sound source using the sensor 140 and/or the camera 160, because it is difficult to accurately identify the location of the sound source only with the sound signals received through the plurality of microphones 110, due to a limited number and arrangement of the plurality of microphones 110, noise or spatial characteristics (e.g., echo).

The processor 150 may identify a location of a first block having the largest beamforming power among the plurality of blocks as the location of the sound source. In this case, the processor 150 may perform photographing in a direction in which the sound source is located through the camera 160 based on the location of the identified sound source.

The processor 150 may identify the location of the user's 200 mouth included in the image based on the image photographed by the camera 160. For example, the processor 150 may identify the mouth, eyes, nose, etc.) of the user 200 included in the image using an image recognition algorithm and identify the location of the mouth. The processor 150 may process a color value of a pixel whose color (or gradation) is within a first predetermined range among a plurality of pixels included in the image as a color value corresponding to black, and process a color value of the pixel whose color value is within a second predetermined range as a color value corresponding to white. In this case, the processor 150 may connect pixels having the color value of black to identify them as an outline, and may identify the pixel having the color value of white as a background. In this case, the processor 150 may calculate, a degree to which a shape of an object pre-stored in a database (e.g., eyes, nose, mouth, etc.) matches the detected outline. In addition, the processor 150 may identify the object having the highest probability value among the probability values calculated for the corresponding outline.

The processor 150 may control the driver 130 so that the display 120 faces the mouth based on the location of the mouth identified through the image.

In contrast, when the user 200 does not exist in the image captured by the camera 160, the processor 150 may identify a location of a second block having a second-largest beamforming power after the first block as a location of the sound source, and control the driver 130 so that the display faces the sound source based on the location of the identified sound source.

Accordingly, the electronic apparatus 100 according to an embodiment of the disclosure may overcome a limitation in hardware or software and accurately identify a location of a sound source in real time.

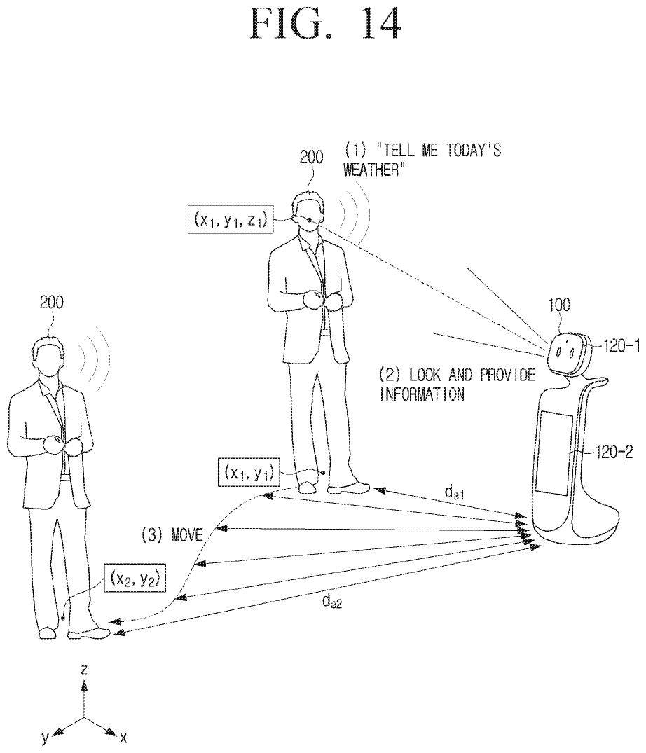

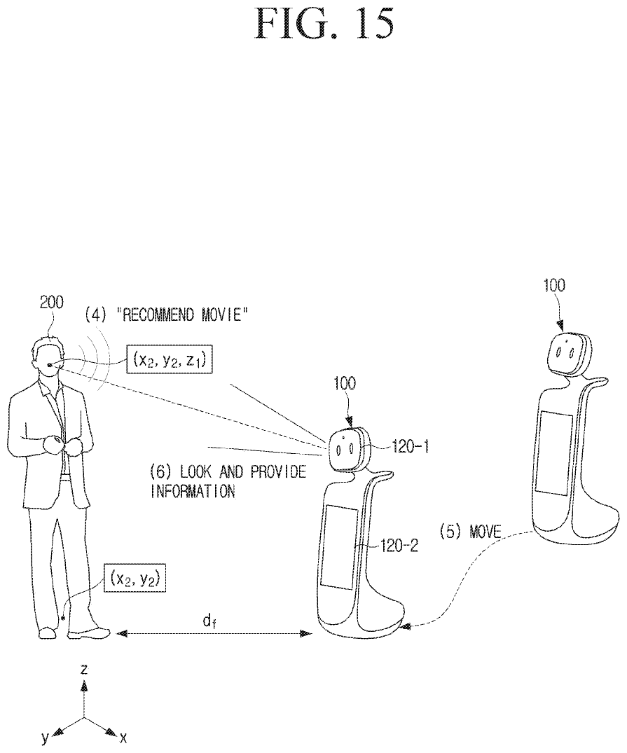

The processor 150 according to an embodiment of the disclosure may map height information on the Z axis of the identified sound source to an object corresponding to a candidate space in which the sound source is located, and track object movement trajectory in space on the XY axis based on the distance information sensed by the sensor 140, and identify a location of a sound source from which a subsequent sound signal was output based on the location of the object in space on the XY axis according to the movement trajectory of the object and height information on the Z axis mapped to the object, when the subsequent sound signal output from the same sound source as the sound signal is received through the plurality of microphones 110. This will be described in detail with reference to FIGS. 14 and 15.

FIGS. 14 and 15 are views illustrating a method of identifying a location of a sound source through a movement trajectory according to an embodiment of the disclosure.

Referring to FIG. 14, as shown in (1) of FIG. 14, the user 200 may generate an acoustic signal (e.g., “tell me today's weather”) by speaking a voice. In this case, as shown in (2) of FIG. 14, when an acoustic signal (e.g., “tell me today's weather”) is received through the plurality of microphones 110, the processor 150 may identify at least one candidate space (e.g., (x1:60, y1:80)) for a sound source in a space around the electronic apparatus 100 based on distance information sensed from the sensor 140, and identify a location of the sound source (e.g., (x1:60, y1:80, z1:175)) from which the sound signal is output by performing sound source location estimation on the identified candidate space. Further, the processor 150 may control the driver 130 so that the display 120 faces the location of the sound source. A detailed description thereof will be omitted in that it overlaps with the above description.

The processor 150 may map height information on the Z axis of the identified sound source to an object corresponding to the candidate space in which the sound source is located. For example, after the location of the sound source (e.g., (x1:60, y1:80, z1:175)) is identified, the processor 150 may map the height information on the Z axis (e.g., (z1:175)) to an object (e.g., user 200) corresponding to a candidate space (e.g., (x1:60, y1:80)) in which the sound source is located.

Thereafter, as shown in (3) of FIG. 14, the user 200 may move the location.

The processor 150 may track the movement trajectory of the object in the XY axis space based on the distance information sensed by the sensor 140. The object for tracking the movement trajectory may include not only the user 200 who uttered the voice, but also an object such as another user. In other words, even if the plurality of objects change their locations or move based on the distance information sensed by the sensor 140, the processor 150 may distinguish the plurality of objects through the movement trajectory.

For example, the processor 150 may track a location of an object over time by measuring distance information sensed by the sensor 140 in the space of the XY axis at each predetermined time period. In this case, the processor 150 may track a change in a location of an object having a value equal to or less than a predetermined value for a continuous period of time as one movement trajectory.

Referring to FIG. 15, as shown in (4) of FIG. 15, the user 200 may generate a subsequent sound signal (e.g., “recommend a movie”) by uttering a voice. In this case, when the subsequent sound signal output from the same sound source as the sound signal as shown in (5) of FIG. 15 is received through the plurality of microphones 110, the processor 150 may identify a location of the sound source (e.g., (x2:−10, y2:30, z1:175)) from the subsequent sound signal is output based on the location (e.g., (x2:−10, y2:30)) of the object in space on the XY axis according to the object's movement trajectory, and height information (e.g., ((z1:175)) on the Z axis mapped to the object. Thereafter, the processor 150 may control the driver 130 so that the display 120 faces the location of the sound source from which the subsequent sound signal is output. The processor 150 may move the electronic apparatus 100 or rotate the electronic apparatus 100 so that the display 120 faces the location of the sound source from which the subsequent sound signal is output. In addition, the processor 150 may control the display 120 to display information (e.g., TOP 10 movie list) in response to the subsequent sound signal.

As such, the processor 150 may identify the location of the sound source based on the object identified through the movement trajectory sensed through the sensor 140, the distance to the object, and height information on the Z axis mapped to the object. In other words, since the location of the sound source can be identified without calculating the beamforming power, the amount of calculation for calculating the location of the sound source may be further reduced.

According to various embodiments of the disclosure as described above, an electronic apparatus 100 and a control method thereof for improving a user experience for a voice recognition service based on a location of a sound source may be provided.

In addition, it is possible to provide an electronic apparatus 100 and a control method thereof that improves accuracy for voice recognition by more accurately searching for a location of a sound source.

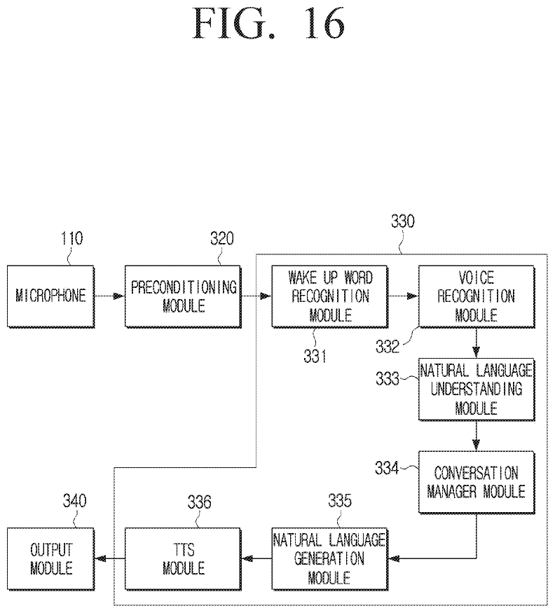

FIG. 16 is a view illustrating a voice recognition according to an embodiment of the disclosure.

Referring to FIG. 16, as a configuration for performing a conversation with a virtual artificial intelligence agent through natural language or controlling the electronic apparatus 100, the electronic apparatus 100 may include a preconditioning module 320, a conversation system 330, and an output module 340. In this case, the conversation system 330 may include a wake-up word recognition module 331, a voice recognition module 332, a natural language understanding module 333, a conversation manager module 334, a natural language generation module 335, and a text to speech (TTS) module 336. According to an embodiment of the disclosure, a module included in the conversation system 330 may be stored in a memory 170 (refer to FIG. 17) of the electronic apparatus 100, but this is only an example, and may be implemented as a combination of hardware and software. Also, at least one module included in the conversation system 330 may be included in at least one external server.

The preconditioning module 320 may perform preconditioning on the sound signals received through the plurality of microphones 110. The preconditioning module 320 may receive an analog sound signal including a voice uttered by the user 200 and may convert the analog sound signal into a digital sound signal. In addition, the preconditioning module 320 may extract a voice section of the user 200 by calculating an energy of the converted digital signal.

The preconditioning module 320 may identify whether the energy of the digital signal is equal to or greater than a predetermined value. When the energy of the digital signal is greater than or equal to the predetermined value, the preconditioning module 320 may enhance the user's voice by removing noise with respect to the digital signal input by identifying as a voice section. When the energy of the digital signal is less than the predetermined value, the preconditioning module 320 may wait for another input, instead of processing the signal with respect to the digital signal. Accordingly, since the entire audio processing is not activated by sounds other than a user 200 voice, unnecessary power consumption may be prevented.

The wake-up word recognition module 331 may identify whether the wake-up word is included in the user's 200 voice through the wake-up model. In this case, the wake-up word (or trigger word, or call word) is a command notifying that the user starts voice recognition (e.g., Bixby, Galaxy, etc.), and the electronic apparatus 100 may execute a conversation system. In this case, the wake-up word may be preset from when manufactured, but this is only an embodiment and may be changed by user setting.

The voice recognition module 332 may convert the user's 200 voice in the form of audio data received from the preprocessor 320 into text data. In this case, the voice recognition module 332 may include a plurality of voice recognition models learned according to characteristics of the user 200, and each of the plurality of voice recognition models may include an acoustic model and a language model. The acoustic model may include information related to speech, and the language model may include information on a combination of unit phoneme information and unit phoneme information. The voice recognition module 332 may convert the user 200 voice into text data by using information related to vocalization and information on unit phoneme information. Information about the acoustic model and the language model may be stored, for example, in an automatic speech recognition database (ASR DB).

The natural language understanding module 333 may perform a syntactic analysis or semantic analysis based on the text data of the user 200 voice acquired through voice recognition, and figure out the user's intent. In this case, the syntactic analysis may divide the user input into syntactical units (e.g., words, phrases, morphemes, etc.), and figure out which syntactical elements the divided units have. The semantic analysis may be performed using semantic matching, rule matching, formula matching, or the like.

The conversation manager module 334 may acquire response information for the user's voice based on the user intention and slot acquired by the natural language understanding module 333. In this case, the conversation manager module 334 may provide a response to the user's voice based on a knowledge database (DB). In this case, the knowledge DB may be included in the electronic apparatus 100, but this is only an embodiment and may be included in an external server. The conversation manager module 334 may include a plurality of knowledge DBs according to user characteristics, and obtain response information for the user voice by using the knowledge DB corresponding to user information among the plurality of knowledge DB. For example, if it is identified that the user is a child based on user information, the conversation manager module 334 may obtain response information for the user voice using the knowledge DB corresponding to the child.

In addition, the conversation manager module 334 may identify whether or not the user's intention identified by the natural language understanding module 333 is clear. For example, the conversation manager module 334 may identify whether the user intention is clear based on whether or not information on the slot is sufficient. The conversation manager module 334 may identify whether the slot identified by the natural language understanding module 333 is sufficient to perform a task. When the user's intention is not clear, the conversation manager module 334 may perform a feedback requesting necessary information from the user.

The natural language generation module 335 may change response information or designated information acquired through the conversation manager module 334 into a text format. The information changed in text form may be in the form of natural language speech. The designated information may be, for example, information for an additional input, information for guiding completion of an operation corresponding to a user input, or information for guiding an additional input by a user (e.g., feedback information for a user input). The information changed in text form may be displayed on the display of the electronic apparatus 100 or may be changed into an audio form by the TTS module 336.

The TTS module 336 may change information in text form into information in voice form. In this case, the TTS module 336 may include a plurality of TTS models for generating responses with various voices.

The output module 340 may output information in the form of voice data received from the TTS module 336. In this case, the output module 340 may output information in the form of audio data through a speaker or an audio output terminal. Alternatively, the output module 340 may output information in the form of text data acquired through the natural language generation module 335 through a display or an image output terminal.

FIG. 17 is a block diagram illustrating an additional configuration of an electronic apparatus according to an embodiment of the disclosure.

Referring to FIG. 17, the electronic apparatus 100 may include at least one of a camera 160, a speaker 165, a memory 170, a communication interface 175, an input interface 180 in addition to a plurality of microphones 110, a display 120, a driver 130, a sensor 140, and a processor 150. A description that overlaps with the above-described content will be omitted.

The sensor 140 may include various sensors such as a lidar sensor 141, an ultrasonic sensor 143 for sensing a distance, or the like. In addition, the sensor 140 may include at least one of a proximity sensor, an illuminance sensor, a temperature sensor, a humidity sensor, a motion sensor, a GPS sensor, or the like.

The proximity sensor may detect an existence of a surrounding object and obtain data on whether the surrounding object exists or whether the surrounding object is close. The illuminance sensor may acquire data on illuminance by sensing the amount of light (or brightness) of the surrounding environment of the electronic apparatus 100. The temperature sensor may sense a temperature of a target object or a temperature of a surrounding environment of the electronic apparatus 100 (e.g., indoor temperature, etc.) according to heat radiation (or photons). In this case, the temperature sensor may be implemented as an infrared camera, or the like. The humidity sensor may acquire data on humidity by sensing the amount of water vapor in the air through various methods such as color change, ion content change, electromotive force, and current change due to a chemical reaction in the air. The motion sensor may sense a moving distance, a moving direction, a tilt, or the like of the electronic apparatus 100. For this operation, the motion sensor may be implemented by a combination of an acceleration sensor, a gyro sensor, a geomagnetic sensor, or the like. The global positioning system (GPS) sensor may receive radio signals from a plurality of satellites, calculate a distance to each satellite using a transmission time of the received signal, and obtain data on a current location of the electronic apparatus 100 by using triangulation.

However, the embodiment of the sensor 140 described above is only an example, and is not limited thereto, and may be implemented with various types of sensors.

The camera 160 may acquire an image, which is a set of pixels, by sensing light in pixel units. Each pixel may include information representing color, shape, contrast, brightness, etc. through a combination of values of red (R), green (G), and blue (B). For this operation, the camera 160 may be implemented with various cameras such as an RGB camera, an RGB-D (Depth) camera, an infrared camera, or the like.

The speaker 165 may output various sound signals. For example, the speaker 165 may generate vibration having a frequency within an audible frequency range of the user 200. For this operation, the speaker 165 may include an analog-to-digital converter (ADC) that converts an analog audio signal into a digital audio signal, a digital-to-analog converter (DAC) that converts a digital audio signal into an analog audio signal, a diaphragm that generates an analog sound wave or acoustic wave, or the like.

The memory 170 is a component in which various information (or data) can be stored. For example, the memory 170 may store information in an electrical form or a magnetic form. At least one instruction, module, or data necessary for the operation of the electronic apparatus 100 or the processor 150 may be stored in the memory 170. The instruction is a unit indicating the operation of the electronic apparatus 100 or the processor 150 and may be written in a machine language that the electronic apparatus 100 or the processor 150 can understand. The module may be an instruction set of a sub-unit constituting a software program, an operating system, an application, a dynamic library, a runtime library, etc., but this is only an embodiment, and the module may be a program itself. Data may be data in units such as bits or bytes that can be processed by the electronic apparatus 100 or the processor 150 to represent information such as letters, numbers, sounds, images, or the like.

The communication interface 175 may transmit and receive various types of data by performing communication with various types of external devices according to various types of communication methods. The communication interface 175 is a circuit that performs various methods of wireless communication, and may include at least one of a Bluetooth module (Bluetooth method), a Wi-Fi module (Wi-Fi method), a wireless communication module (cellular method such as 3^{rd} Generation (3G), 4^{th} Generation (4G), 5^{th} Generation (5G), etc.), a near field communication (NFC) module (NFC method), an IR module (infrared method), Zigbee module (Zigbee method), an ultrasonic module (ultrasonic method), or the like, and Ethernet module performing wired communication, USB module, high definition multimedia interface (HDMI), display port (DP), D-subminiature (D-SUB), digital visual interface (DVI), Thunderbolt and components. In this case, a module for performing wired communication may perform communication with an external device through an input/output port.

The input interface 180 may receive various user commands and transmit them to the processor 150. The processor 150 may recognize a user command input from the user through the input interface 180. The user command may be implemented in various ways, such as a user's touch input (touch panel), a key (keyboard) or button (physical button, mouse, etc.) input, a user's voice (microphone), or the like.

The input interface 180 may include at least one of, for example, a touch panel (not shown), a pen sensor (not shown), a button (not shown), and a microphone (not shown). The touch panel may, for example, use at least one of electrostatic type, pressure sensitive type, infrared type, and a ultraviolet type. The touch panel further includes a control circuit, and it is possible to provide tactile response to the user by further including the tactile layer. The pen sensor, for example, may be part of the touch panel or include a separate detection sheet. The button may include, for example, a button that detects a user's contact, a button that detects a pressed state, an optical key or a keypad. The microphone may directly receive the user's voice, and may obtain an audio signal by converting the user's voice, which is an analog signal, to digital by a digital converter (not shown).

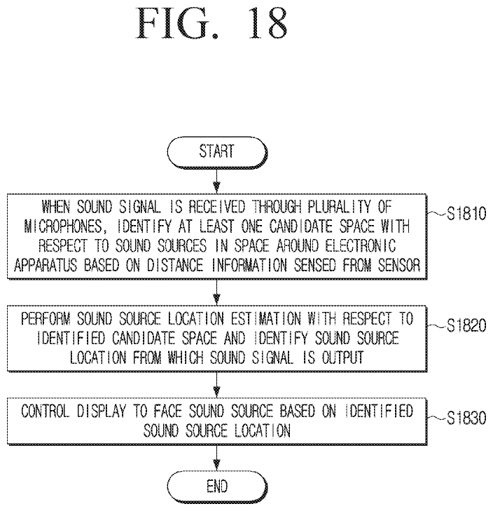

FIG. 18 is a view illustrating a flowchart according to an embodiment of the disclosure.

Referring to FIG. 18, a method of controlling the electronic apparatus 100 may include identifying at least one candidate space with respect to a sound source in a space around the electronic apparatus using distance information sensed by the sensor 140 in operation S1810, identifying a location of the sound source from which the acoustic signal is output by performing sound source location estimation with respect to the identified candidate space in operation S1820, and controlling the driver 130 so that the display 120 faces the identified location of the sound source in operation S1830.

When an acoustic signal is received through the plurality of microphones 110, at least one candidate space for a sound source may be identified in a space around the electronic apparatus 100 using distance information sensed by the sensor 140. in operation S1810.

The identifying the candidate space may identify at least one object having a predetermined shape around the electronic apparatus 100 based on distance information sensed by the sensor 140. In this case, at least one candidate space may be identified based on the location of the identified object.

The identifying the candidate space may identify at least one object having a predetermined shape in the space of the XY axis around the electronic apparatus 100 based on distance information sensed by the sensor 140. In this case, with respect to the area in which the object identified in the space of the XY axis is located, at least one space having a predetermined height in the Z axis may be identified as at least one candidate space.

The predetermined shape may be a shape of the user's 200 foot. The shape represents curvature, shape, and size of the object in the XY axis space. However, this is only an embodiment, and the predetermined shape may be set to various shapes such as the shape of the user 200's face, the shape of the upper or lower body of the user 200, the shape of the user 200's body, or the like.

A location of the sound source from which an acoustic signal is output may be identified by performing a sound source location estimation with respect to the identified candidate space in operation S1820.

The sound source may be the user 200's mouth.

The identifying the location of the sound source may divide each of the identified candidate spaces into a plurality of blocks, and perform sound source location estimation that calculates a beamforming power for each block. In this case, the location of the block having the largest calculated beamforming power may be identified as a location of the sound source.

A location of a first block having the largest beamforming power among a plurality of blocks may be identified as a location of a sound source. In this case, on the basis of the location of the identified sound source, the camera 160 may photograph in a direction in which the sound source is located. If the user 200 does not exist in the image photographed by the camera 160, a location of a second block having the second-largest beamforming power after the first block may be identified as the location of the sound source. In this case, based on the location of the identified sound source, the driver 130 may be controlled so that the display 120 faces the sound source.

Based on the identified location of the sound source, the driver 130 may be controlled so that the display 120 faces the identified location of the sound source in operation S1830.

The display 120 may be located on the head 10 of the head 10 and the body 20 constituting the electronic apparatus 100. In this case, an angle of the head 10 may be adjusted through the driver 130 so that the display 120 faces the location of the identified sound source.

When a distance between the electronic apparatus 100 and the sound source is less than or equal to a predetermined value, at least one of a direction and an angle of the head 10 of the electronic apparatus 100 may be adjusted through the driver 130 so that the display 120 faces the sound source. Alternatively, when the distance between the electronic apparatus 100 and the sound source exceeds the predetermined value, the electronic device 100 may be moved to a point away from the sound source by a predetermined distance through the driver 130 so that the display 120 faces the sound source, and the angle of the head 10 may be adjusted.

The control method of the electronic apparatus 100 of the disclosure may perform photographing in a direction in which the sound source is located through the camera 160 based on the location of the identified sound source. In this case, based on an image photographed by the camera 160, a location of the user 200's mouth included in the image may be identified. In this case, the driver 130 may be controlled so that the display 120 faces the identified location of the mouth.

Height information on the Z axis of the identified sound source may be mapped to an object corresponding to a candidate space in which the sound source is located. In this case, a movement trajectory of the object in the space of the XY axis may be tracked based on the distance information sensed by the sensor 140. In this case, when a subsequent acoustic signal output from the same sound source as the acoustic signal is received through the plurality of microphones 110, the location of the sound source to which a subsequent acoustic signal is output from may be identified based on a location of the object in space on the XY axis according to the movement trajectory of the object and height information on the Z axis mapped to the object.

According to various embodiments of the disclosure as described above, an electronic apparatus 100 for improving a user experience for a voice recognition service based on a location of a sound source, and a control method thereof may be provided.

In addition, it is possible to provide an electronic apparatus 100 that improves accuracy for voice recognition by more accurately searching for a location of a sound source, and a control method thereof.

According to an embodiment of the disclosure, the various embodiments described above may be implemented as software including instructions stored in a machine-readable storage media which is readable by a machine (e.g., a computer). The device may include the electronic device according to the disclosed embodiments, as a device which calls the stored instructions from the storage media and which is operable according to the called instructions. When the instructions are executed by a processor, the processor may directory perform functions corresponding to the instructions using other components or the functions may be performed under a control of the processor. The instructions may include code generated or executed by a compiler or an interpreter. The machine-readable storage media may be provided in a form of a non-transitory storage media. The ‘non-transitory’ means that the storage media does not include a signal and is tangible, but does not distinguish whether data is stored semi-permanently or temporarily in the storage media.

The computer program product may be distributed in a form of the machine-readable storage media (e.g., compact disc read only memory (CD-ROM) or distributed online through an application store (e.g., PlayStore™). In a case of the online distribution, at least a portion of the computer program product may be at least temporarily stored or provisionally generated on the storage media, such as a manufacturer's server, the application store's server, or a memory in a relay server.

According to various embodiments, each of the elements (e.g., a module or a program) of the above-described elements may be comprised of a single entity or a plurality of entities. According to various embodiments, one or more elements of the above-described corresponding elements or operations may be omitted, or one or more other elements or operations may be further included. Alternatively or additionally, a plurality of elements (e.g., modules or programs) may be integrated into one entity. In this case, the integrated element may perform one or more functions of the element of each of the plurality of elements in the same or similar manner as being performed by the respective element of the plurality of elements prior to integration. According to various embodiments, the operations performed by a module, program, or other elements may be performed sequentially, in a parallel, repetitively, or in a heuristically manner, or one or more of the operations may be performed in a different order, omitted, or one or more other operations may be further included.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a plurality of microphones;
a display;
a driver;
a sensor configured to sense a distance to an object around the electronic apparatus; and
a processor configured to:
based on an acoustic signal being received through the plurality of microphones, identify at least one candidate space with respect to a sound source in a space around the electronic apparatus using distance information sensed by the sensor,
identify a location of the sound source from which the acoustic signal is output by performing sound source location estimation with respect to the identified candidate space, and
control the driver such that the display faces the identified location of the sound source.

2. The electronic apparatus of claim 1, wherein the processor is further configured to:
identify at least one object having a predetermined shape around the electronic apparats based on distance information sensed by the sensor, and
identify the at least one candidate space based on a location of the identified object.

3. The electronic apparatus of claim 1, wherein the processor is further configured to:
identify at least one object having a predetermined shape in a space of an XY axis around the electronic apparatus based on the distance information sensed by the sensor, and
with respect to an area where the identified object is located in the space of the XY axis, identify at least one space having a predetermined height in a Z axis as the at least one candidate space.

4. The electronic apparatus of claim 2, wherein the predetermined shape is a shape of a user's foot.

5. The electronic apparatus of claim 2, wherein the processor is further configured to map height information on the Z axis of the identified sound source to an object corresponding to the candidate space in which the sound source is located,
wherein track a movement trajectory of the object in the space of the XY axis based on the distance information sensed by the sensor, and
wherein based on a subsequent acoustic signal output from the same sound source as the acoustic signal being received through the plurality of microphones, identify a location of a sound source from which the subsequent acoustic signal is output based on a location of the object in the space of the XY axis according to the movement trajectory of the object and the height information on the Z axis mapped to the object.

6. The electronic apparatus of claim 1, wherein the sound source is a mouth of a user.

7. The electronic apparatus of claim 1, further comprising:
a camera,
wherein the processor is configured to photograph in a direction where the sound source is located through the camera based on the location of the identified sound source,
wherein, based on an image photographed by the camera, identify a location of a user's mouth included the image, and
wherein control the driver such that the display faces the mouth based on the location of the mouth.

8. The electronic apparatus of claim 1, wherein the processor is configured to divide each of the identified candidate spaces into a plurality of blocks to perform the sound source location estimation that calculates a beamforming power with respect to each block, and identify a location of the block having the largest calculated beamforming power as the location of the sound source.

9. The electronic apparatus of claim 8, further comprising:
a camera,
wherein the processor is further configured to:
identify a location of a first block having the largest beamforming power among the plurality of blocks as the location of the sound source,
photograph an image in a direction in which the sound source is located through the camera based on the location of the identified sound source,
based on a user not being present in the image photographed by the camera, identify a location of a second block having the second-largest beamforming power after the first block as the location of the sound source, and
control the driver such that the display faces the sound source based on the location of the identified sound source.

10. The electronic apparatus of claim 1,
wherein the display is located on a head of the electronic apparatus, and
wherein the processor is further configured to:
based on a distance between the electronic apparats and the sound source being less than or equal to a predetermined value, adjust at least one of a direction of the electronic apparats and an angle of the head through the driver such that the display faces the sound source, and
based on the distance between the electronic apparatus and the sound source exceeding the predetermined value, move the electronic apparatus to a point distant from the sound source by the predetermined value through the driver, and adjust the angle of the head such that the display faces the sound source.

11. A method of controlling an electronic apparatus, the method comprising:
based on an acoustic signal being received through a plurality of microphones, identifying at least one candidate space with respect to a sound source in a space around the electronic apparatus using distance information sensed by a sensor;
identifying a location of the sound source from which the acoustic signal is output by performing sound source location estimation with respect to the identified candidate space; and
controlling a driver of the electronic apparatus such that the display faces the identified location of the sound source.

12. The method of claim 11, wherein the identifying of the candidate space comprises:
identifying at least one object having a predetermined shape around the electronic apparats based on distance information sensed by the sensor, and
identifying the at least one candidate space based on a location of the identified object.

13. The method of claim 12, wherein the identifying of the candidate space comprises:
identifying at least one object having a predetermined shape in a space of an XY axis around the electronic apparatus based on the distance information sensed by the sensor, and
with respect to an area where the identified object is located in the space of the XY axis, identifying at least one space having a predetermined height in a Z axis as the at least one candidate space.

14. The method of claim 12, wherein the predetermined shape is a shape of a user's foot.

15. The method of claim 12, wherein the identifying of the location of the sound source comprises:
mapping height information on the Z axis of the identified sound source to an object corresponding to the candidate space in which the sound source is located;
tracking a movement trajectory of the object in a space of the XY axis based on the distance information sensed by the sensor; and
based on a subsequent acoustic signal output from the same sound source as the acoustic signal being received through the plurality of microphones, identifying a location of a sound source from which the subsequent acoustic signal is output based on a location of the object in the space of the XY axis according to the movement trajectory of the object and the height information on the Z axis mapped to the object.

16. The method of claim 11, wherein the sound source is a mouth of the user.

17. The method of claim 11, further comprising:
photographing in a direction where the sound source is located through a camera of the electronic apparatus based on the location of the identified sound source;
based on an image photographed by the camera, identifying a location of the user's mouth included the image; and
controlling the driver such that the display faces the mouth based on the location of the mouth.

18. The method of claim 11, wherein the identifying of the location of the sound source comprises:
dividing each of the identified candidate spaces into a plurality of blocks to perform a sound source location estimation that calculates a beamforming power with respect to each block; and
identifying a location of the block having the largest calculated beamforming power as the location of the sound source.

19. The method of claim 18, further comprising:
identifying a location of a first block having the largest beamforming power among the plurality of blocks as the location of the sound source;
photographing an image in a direction in which the sound source is located through camera of the electronic apparatus based on the location of the identified sound source;
based on the user being not existed in the image photographed by the camera, identifying a location of a second block having the second-largest beamforming power after the first block as the location of the sound source; and
controlling the driver such that the display faces the sound source based on the location of the identified sound source.

20. The method of claim 11,
wherein the display is located on a head of the electronic apparatus, and
wherein the method further comprises:
based on a distance between the electronic apparatus and the sound source being less than or equal to a predetermined value, adjusting at least one of a direction of the electronic apparats and an angle of the head through the driver such that the display faces the sound source; and
based on the distance between the electronic apparatus and the sound source exceeding the predetermined value, moving the electronic apparatus to a point distant from the sound source by the predetermined value through the driver, and adjusting the angle of the head such that the display faces the sound source.
